(19) United States
(12) Patent Application Publication
(10) Pub. No.: US 2010/0293213 A1
(43) Pub. Date: Nov. 18, 2010

(54) Method and apparatus for approximating a function

(76) Inventors: Hong Jiang, Warren, NJ (US); Paul A. Wilford, Bernardsville, NJ (US)

Correspondence Address: Alcatel-Lucent USA Inc.;Docket Administrator, Room 2F-192, 600-700 Mountain Ave., Murray Hill, NJ, 07974-0636, US

(21) Appl. No.: 12/454,229

(22) Filed: May 14, 2009

(51) Int. Cl. G06F 1/02

(52) U.S. Cl. 708/270

(57) ABSTRACT

Embodiments described herein provide techniques for computing an approximation of a function. These embodiments provide an iterative method that avoids the computation of the normal matrix and/or the coefficients, as is typical in the prior art. (See diagram 600, for example.) The iterative method works on the functions directly. At each iteration, the approximating function is computed directly. (See diagram 200.) Since there is no need to compute the normal matrix or the coefficients of the basis functions, this approach avoids the overhead associated with them, and therefore, increases the speed of computation and reduces resource requirements. For example, various embodiments are suitable for implementation on hardware devices such as on an FPGA or an ASIC.

### REFERENCES(S) TO RELATED APPLICATION(S)

This application is related to a co-pending application, Ser. No. 12/384,512, entitled “METHOD AND APPARATUS FOR PERFORMING PREDISTORTION,” filed Apr. 6, 2009, which is commonly owned and incorporated herein by reference in its entirety.

### FIELD OF THE INVENTION

The present invention relates generally to techniques for approximating functions and, in particular, to techniques for approximating functions used in communications.

### BACKGROUND OF THE INVENTION

In computing the predistortion to linearize a high power amplifier (HPA), the function that best approximates the inverse function of the HPA needs to be computed. This can be characterized as a best approximation problem. Typically, solutions using iterative methods for such approximation problems form the normal equations for the coefficients of the best approximation. See diagram 600 in FIG. 6, for example. First, the best approximation is expressed as a combination of some basis functions, with a set of coefficients. Then the normal equations are formed for the coefficients. The solution to the normal equations is the set of coefficients which are to be used to form the best approximation. In an iterative method, the normal equations are solved by an iterative approach such as the conjugate gradient (CG) method. After the coefficients are computed from the normal equations, the best solution is found by forming the combination of the basis functions with the computed coefficients.

However, disadvantages of such a solution include the fact that the normal matrix for the normal equations must be computed for the coefficients to be computed. Also, after the coefficients are computed, the best approximation needs to be formed with the coefficients. These computations require resources such as storage and computing cycles that slow the solution process and increase the cost of devices that implement such solutions. Therefore, new solutions for such best approximation problems that are able to address some of these known disadvantages in are desirable.

### BRIEF DESCRIPTION OF THE DRAWINGS

FIG. 1 is a block diagram depiction illustrating a polynomial predistorter architecture.

FIG. 2 is a logic flow diagram of functionality for finding the best approximation in accordance with various embodiments of the present invention.

FIG. 3 is a logic flow diagram of functionality for determining an approximation function in accordance with more detailed embodiments of the present invention.

FIG. 4 is a block diagram depiction illustrating an architecture for using predistortion to linearize the output of a high power amplifier (HPA).

FIG. 5 is a graphical depiction of the performance of the SCG_MUL algorithm as simulated.

FIG. 6 is a logic flow diagram of functionality for finding the best approximation in accordance with the prior art.

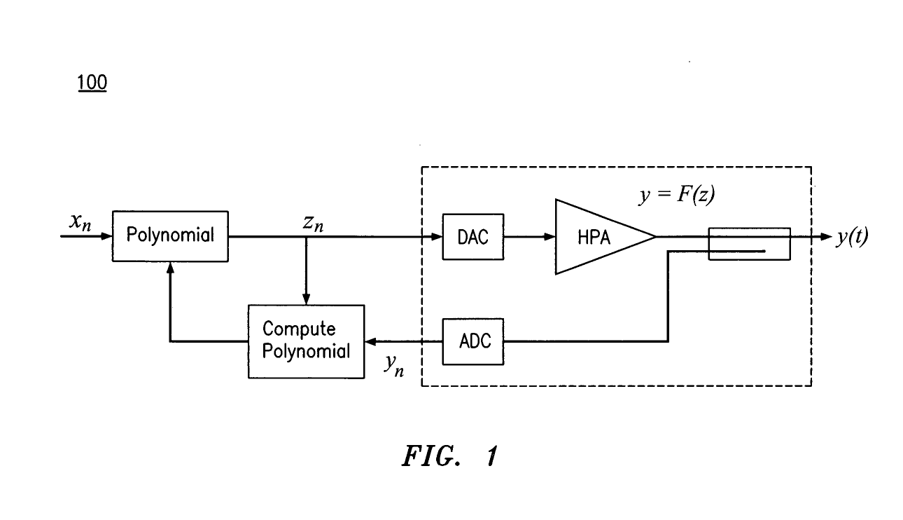

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

To address the need for new solutions to best approximation problems, various embodiments are described. Many embodiments involve a method in which a first approximating function is iteratively computed using a stochastic conjugate gradient method (SCG) and a set of basis functions. The first approximating function is used to generate output data which is subsequently used to compute a second approximating function.

Certain embodiments, such as those depicted by logic flow diagram 300, involve a more detailed method for approximating a function. Given a set of basis functions (301) and a first set of input data and a first set of output data (302), a first approximating function is computed (305) using a stochastic conjugate gradient method (SCG). Using the first approximating function a second set of output data is generated. Using this second set of output data and a second set of input data (302), a second approximating function is computed (305). In some embodiments, a residual is computed (303) using the first set of input data and the first set of output data, and based on the residual and the set of basis functions, a search direction is computed (304). The second approximating function may thus be computed (305) additionally using this search direction.

Also described are apparatus embodiments in which a function approximator includes interface circuitry and logic circuitry, coupled to the interface circuitry. The logic circuitry is adapted to utilize a stochastic conjugate gradient method (SCG) to iteratively compute a first approximating function using a set of basis functions, adapted to receive via the interface circuitry output data generated using the first approximating function, and adapted to compute a second approximating function using the output data.

### Detailed Description of Embodiments

Embodiments are described herein to provide an apparatus and a method for computing an approximation of a function. Function approximation has wide applications in many fields. One application area of the invention is the linearization of high power amplifiers. The problem is to find the function among a class of functions that best approximates a given function. It is desired to compute the approximation of the given function by using an iterative method in which an approximation of the given function is computed at each iteration, and the approximation gets successively better as iteration increases. Various embodiments described herein provide an iterative method that is more efficient in terms of required resources and computing speed than existing solutions.

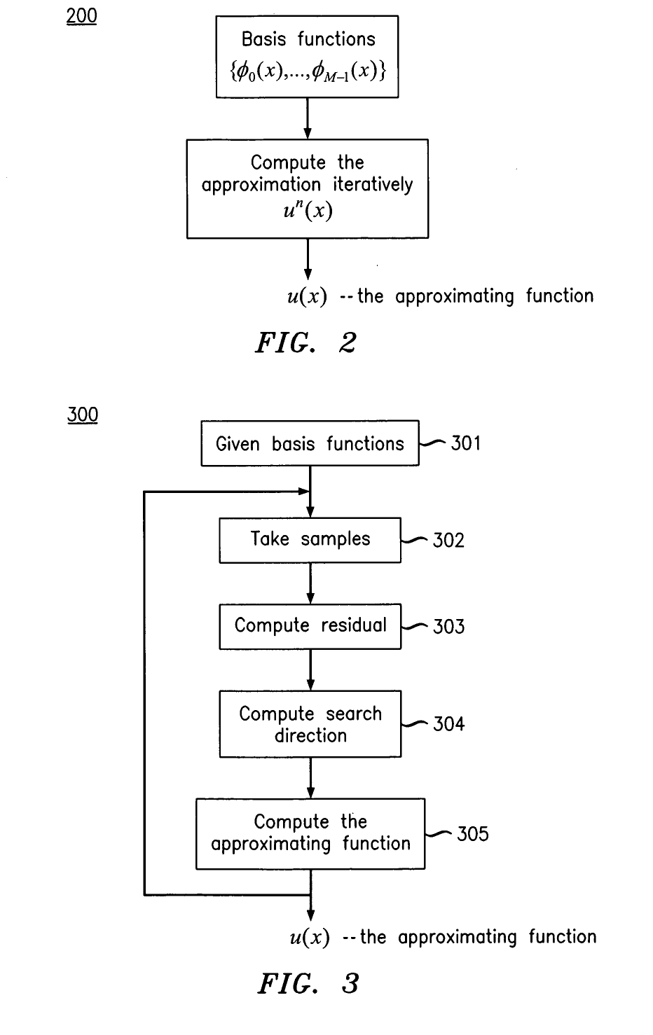

FIG. 2 is a logic flow diagram of functionality for finding the best approximation in accordance with various embodiments of the present invention. These embodiments provide an iterative method that avoids the computation of the normal matrix and/or the coefficients. (Compare diagram 200 with diagram 600, for example.) The iterative method works on the functions directly. At each iteration, the approximating function is computed directly. Since there is no need to compute the normal matrix or the coefficients of the basis functions, this approach avoids the overhead associated with them, and therefore, increases the speed of computation and reduces resource requirements. For example, various embodiments are suitable for implementation on hardware devices such as on a field-programmable gate array (FPGA) or an application-specific integrated circuit (ASIC).

To provide a greater degree of detail in making and using various aspects of the present invention, a description of certain, quite specific, embodiments follows for the sake of example. FIGS. 1 and 3-5 are referenced in an attempt to illustrate some examples of specific embodiments of the present invention and/or how some specific embodiments may operate.

A list of references is provided below and is referred throughout the description that follows:
[1] Gene H. Golub, Charles F. Van Loan, “Matrix Computations”, 2^{nd} Ed, Johns Hopkins University Press, Baltimore and London, 1989, p 522.
[2] P. S. Chang and A. N. Willson, Jr., “Analysis of conjugate gradient algorithms for adaptive filtering,” IEEE Trans. Signal Process., vol. 48, no. 2, pp. 409-418, February 2000.
[3] “A generalized memory polynomial model for digital predistortion of RF power amplifiers”, IEEE transc signal processing, Vol. 54, No. 10, 2006, p 3852.
[4] Gregory Beylkin, Jochen Garcke and Martin J. Mohlenkamp, “MULTIVARIATE REGRESSION AND MACHINE LEARNING WITH SUMS OF SEPARABLE FUNCTIONS”, submitted for publication, 2007.
[5] “A robust digital baseband predistorter constructed using memory polynomials”, IEEE TRANSACTIONS ON COMMUNICATIONS, VOL. 52, NO. 1, 2004, p159.

We are interested in approximating a function of one variable by a linear combination of a set of linearly independent basis functions. For example, we want to approximate a function by a polynomial of degree less than or equal to a given number.

The function to be approximated may not be known explicitly. However, it is observable through samples. For example, in the application of linearization of high power amplifiers (HPA), the inverse function of the transfer function of the HPA is to be approximated by a polynomial [3]. Although the inverse function of HPA transfer is not known explicitly, it can be observed by monitoring the input and output samples of HPA.

Usually, the observed samples are from a random process. In addition, the availability of samples is unlimited; samples are always available for observation, although there may be a limit on how many samples one can observe at once. In the example of the HPA linearization, the samples are usually from a waveform such as an OFDM signal, which behaves as a random process with certain probability density function. Since the OFDM signal is continuously transmitted, one can always capture samples when desired, but the number of samples per capture may be limited by available hardware resources.

Since the function to be approximated is known only through observations, the approximation of the function is computed for each set of samples from an observation. This naturally defines an iterative process in which a series of approximations are computed for a series of sample sets, with the expectation that the approximations get progressively more accurate as more sample sets are taken.

The function to be approximated may not be stationary, in the sense that properties of the function may change over time. There is, therefore, a need to update the approximation constantly. Furthermore, it is desirable to perform the update as quickly as possible, for example, one update per observed sample [2].

In many applications, finding the best approximation of a function is just an intermediate step in an overall iterative scheme. For example, in approximating multivariate functions [4], the solution is found iteratively, and in each iteration, the best approximation of a function of one variable is solved. Also, nonlinear problems can be solved iteratively in which a linear problem is solved at each iteration. In such applications, the solution to the intermediate step may not need to be exact. Rather, a mechanism of being able to produce a relatively accurate approximation quickly will speed up the convergence of the overall iteration.

The best approximation of a function is normally carried out by the least squares method in which a linear combination of the basis functions is sought so that it best matches the observed output samples when evaluated at the observed input samples. The coefficients of the least squares solution satisfy the normal equations. The normal equations can be solved by an iterative method such as the conjugate gradient (CG) method.

An iterative method for solving the normal equations is attractive for many reasons. An iterative method produces an approximation of the solution in far fewer operations than what is needed in a direct method such as Cholesky decomposition. This makes it possible to update the approximation quickly in applications where the least squares solution is just an intermediate solution in an overall iterative scheme. Usually, only a very few iterations (one or two) are performed for the intermediate solution. Also, the CG method involves only vector additions and vector products, which are particularly amenable to implementation in hardware such as on an FPGA. On the contrary, the Cholesky decomposition usually requires implementation on a microprocessor, which may be costly or slow to obtain the solutions.

In the CG method, one needs to compute the normal matrix first. Then, the matrix is used in the iterations, and the coefficients for the least squares approximation are computed at each iteration. After the iteration is terminated, the coefficients are used to form the linear combination of the basis functions to produce the approximating function, which will be used for further processing in other modules of an application. The computations the normal matrix is expensive, it requires O(M²N) operations, where M is the number of basis functions, and N is the number of samples used to compute the approximation. For example, in polynomial approximations, M is the highest degree of polynomials. This is normally not a concern if the CG method is used to produce a very accurate solution and many iterations are performed with one computation of the normal matrix. However, in the applications in which the CG iteration is only an intermediate step, and only one or two iterations are performed for each computation of the normal matrix, this overhead is costly.

A stochastic CG method is described herein that avoids the computation of the normal matrix. The iterations are carried out on the functions or the representation of the functions themselves directly. At each iteration, the approximating function is computed, which can be directly used for further processing by other modules of an application. There is no need for the round-about of forming the normal matrix, finding the coefficients, and then computing the function by linear combination of the basis functions using the coefficients. This avoids the overhead involved in computing the normal matrix and forming the linear combination. The complexity of the stochastic CG method is O(MN) as opposed to O(M²N) when the CG method is used on the normal equations.

A theoretical formulation follows. Let g(x) be a complex valued function defined on [0,1]. Let Y(t) be a random process with probability density function

$$ρ ( x ) > 0 and {\int }_{0}^{1} ρ ( x ) d x = 1.$$

Let Z(t)=g(Y(t)). We assume ρ(x) is known. However, the function g(x) may not be known explicitly, but the random process Z(t) can be observed, and its samples can be taken as desired.

Let {φ₀(x), . . . ,φ_{M-1}(x)} be a set of linearly independent complex valued functions of real variable defined on the interval [0,1]. Denote φ=[φ₀(x),φ₁(x) . . . ,φ_{M-1}(x)]^{T}. For example, {φ₀(x),φ₁(x) . . . ,φ_{M-1}(x)}={1,x . . . ,x^{M-1}}, which forms a basis for the polynomials of degree less than or equal to M−1. Denote E(y) as the expected value of the random variable y, and y* as the complex conjugate of y.

The best approximation problem we are concerned with is to find a linear combination of the basis functions {φ₀(x), . . . ,φ_{M-1}(x)} which best approximates g(x).

$$Problem 1 \\ Find u ( x ) = {\sum }_{i = 0}^{M - 1} {u}_{i} {φ}_{i} ( x ) , \\ such that \\ E ( {( g ( Y ) - u ( Y ) )}^{*} ( g ( Y ) - u ( Y ) ) ) = E ( {( Z - {\sum }_{i = 0}^{M - 1} {u}_{i} {φ}_{i} ( Y ) )}^{*} ( Z - {\sum }_{i = 0}^{M - 1} {u}_{i} {φ}_{i} ( Y ) ) ) = min \{ E ( {( Z - v ( Y ) )}^{*} ( Z - v ( Y ) ) \vert v ∈ span \{ {φ}_{0} ( x ) , {φ}_{1} ( x ) … , {φ}_{M - 1} ( x ) \} \} \qquad ( 1 )$$

The solution to Problem 1 can be readily obtained through solving normal equations. Define the inner product [symbol] •,• [symbol] of complex valued functions of a real variable on interval [0,1] to be

$$〈 f , g 〉 = E ( {f}^{*} g ) = {\int }_{0}^{1} ρ ( x ) {f}^{*} ( x ) g ( x ) d x . \qquad ( 2 )$$

Define the norm ∥•∥ by μf∥²= [symbol] f,f [symbol] . With these definitions, equation (1) is equivalent to

$$\begin{matrix}‖ g ( x ) - u ( x ) ‖ = ‖ g ( x ) - {\sum }_{i = 0}^{M - 1} {u}_{i} {φ}_{i} ( x ) ‖ \\ = min \{ \begin{matrix}‖ g ( x ) - v ( x ) ‖ \vert v ∈ span \\ \{ {φ}_{0} ( x ) , {φ}_{1} ( x ) … , {φ}_{M - 1} ( x ) \}\end{matrix} \}\end{matrix} \qquad ( 3 )$$

It is well known that solving (3) is equivalent to solving the normal equations

Au=b (4)

where A=A(φ) is the M×M covariance matrix whose entries are given by

aᵢⱼ= [symbol] φᵢ,φⱼ [symbol] (5)

and c and b are is the M—vectors given by u=[u₀, . . . ,u_{M-1}]^{T}, b=[b₀, . . . ,b_{M-1}]^{T} with

bᵢ= [symbol] φᵢ,g [symbol] . (6)

Therefore, the solution to Problem 1 is completely determined if the inner products in equations (5) and (6) are known.

The solution u =[u₀, . . . ,u_{M-1}]^{T} to the normal equations can be found iteratively using the conjugate gradient method. After the coefficients u=[u₀, . . . ,u_{M-1}]^{T} are computed, the approximating function u(x) can be obtained by

$$u ( x ) = {\sum }_{i = 0}^{M - 1} {u}_{i} {φ}_{i} ( x ) .$$

Algorithm CG [1]:

k = 0; u⁰ = 0; r⁰ = b;
while r^{k} ≠ 0

k = k + 1
if k = 1

v¹ = r⁰

else

$\begin{matrix}{β}_{k} = \frac{{( {r}^{k - 1} )}^{H} {r}^{k - 1}}{{( {r}^{k - 2} )}^{H} {r}^{k - 2}} \\ {v}^{k} = {r}^{k - 1} + {β}_{k} {v}^{k - 1}\end{matrix}$

end
$\begin{matrix}{α}_{k} = \frac{{( {r}^{k - 1} )}^{H} {r}^{k - 1}}{{( {v}^{k} )}^{H} {Av}^{k}} \\ {u}^{k} = {u}^{k - 1} + {α}_{k} {v}^{k} \\ {r}^{k} = b - {Au}^{k}\end{matrix}$

end

From this, we can formulate an equivalent algorithm that operates directly on the functions, rather than the coefficients. Although the formulation can be made directly with the vector space {φ₀(x), . . . ,φ_{M-1}(x)}, we choose to use the following approach to reveal the relationship between the two algorithms acting on the coefficients and the functions.

We may associate each M—vector u=[u₀, . . . ,u_{M-1}]^{T} with a function as

$$u ( x ) = {φ}^{T} u = {\sum }_{i = 0}^{M - 1} {u}_{i} {φ}_{i} ( x )$$

For any two M—vectors u, v, we have

$$\begin{matrix}{u}^{H} Av = {\sum }_{i = 0}^{M - 1} {u}_{i}^{*} {\sum }_{j = 0}^{M - 1} {a}_{ij} {v}_{j} \\ = {\sum }_{i = 0}^{M - 1} {u}_{i}^{*} {\sum }_{j = 0}^{M - 1} 〈 {φ}_{i} , {φ}_{j} 〉 {v}_{j} \\ = {\sum }_{i = 0}^{M - 1} {u}_{i}^{*} 〈 {φ}_{i} , {\sum }_{j = 0}^{M - 1} {v}_{j} {φ}_{j} 〉 \\ = 〈 {\sum }_{i = 0}^{M - 1} {u}_{i} {φ}_{i} , {\sum }_{j = 0}^{M - 1} {v}_{j} {φ}_{j} 〉 \\ = 〈 u ( x ) , v ( x ) 〉\end{matrix} \qquad ( 7 )$$

In above, the right hand is the inner product of two functions.

Multiplying φ^{T}=[φ₀(x),φ₁(x) . . . ,φ_{M}₋(x)] to the vectors in each step of the Algorithm CG, we can convert the vectors into functions. In particular, we have the following equalities

$$\begin{matrix}{φ}^{T} b = {\sum }_{i = 0}^{M - 1} {b}_{i} {φ}_{i} ( x ) \\ = {\sum }_{i = 0}^{M - 1} 〈 {φ}_{i} ( x ) , g ( x ) 〉 {φ}_{i} ( x )\end{matrix}$$

$$\begin{matrix}{φ}^{T} {Au}^{k} = {\sum }_{i = 0}^{M - 1} {\sum }_{j = 0}^{M - 1} {u}_{j}^{k} 〈 {φ}_{i} ( x ) , {φ}_{j} ( x ) 〉 {φ}_{i} ( x ) \\ = {\sum }_{i = 0}^{M - 1} 〈 {φ}_{i} ( x ) , {u}^{k} ( x ) 〉 {φ}_{i} ( x )\end{matrix}$$

Therefore, the following algorithm is the conjugate gradient method on functions (CGF) for solving Problem 1.

Algorithm CGF:

$\begin{matrix}k = 0 ; {u}^{0} ( x ) = 0 ; \\ {γ}_{i}^{0} = 〈 {φ}_{i} ( x ) , g ( x ) 〉 , i = 0 , … , M - 1 ; \\ {r}^{0} ( x ) = {\sum }_{i = 0}^{M - 1} {γ}_{i}^{0} {φ}_{i} ( x ) ; \\ while ‖ {r}^{k} ( x ) ‖ \neq 0\end{matrix}$

k = k + 1
if k = 1

v¹(x) = r⁰(x)

else

$\begin{matrix}{β}_{k} = \frac{{( {γ}^{k - 1} )}^{H} {γ}^{k - 1}}{{( {γ}^{k - 2} )}^{H} {γ}^{k - 2}} \\ {v}^{k} ( x ) = {r}^{k - 1} ( x ) + {β}_{k} {v}^{k - 1} ( x )\end{matrix}$

end
$\begin{matrix}{α}_{k} = \frac{{( {γ}^{k - 1} )}^{H} {γ}^{k - 1}}{〈 {v}^{k} ( x ) , {v}^{k} ( x ) 〉} \\ {u}^{k} ( x ) = {u}^{k - 1} ( x ) + {α}_{k} {v}^{k} ( x ) \\ {γ}_{i}^{k} = 〈 {φ}_{i} ( x ) , g ( x ) - {u}^{k} ( x ) 〉 , i = 0 , … , M - 1 ; \\ {γ}^{k} = {[ {γ}_{0}^{k} , … , {γ}_{M - 1}^{k} ]}^{T} \\ {r}^{k} ( x ) = {\sum }_{i = 0}^{M - 1} {γ}_{i}^{k} {φ}_{i} ( x )\end{matrix}$

end
u(x) = u^{k}(x)

The function u(x) after the termination of Algorithm CGF is the solution to Problem 1. Note that Algorithm CGF does not require the covariance matrix A.

Although CG/CGF produces an exact solution to Problem 1 in a finite number of iterations, these algorithms may not be realized. When the function to be approximated, g(x), is not explicitly known, the inner products involving g(x), for example, equation (6), need to be computed in some practical ways. This will be discussed in detail below.

### Rate of Convergence and Orthonormal Basis

Both CG and CGF will terminate after a maximum of M iterations. However, as an iterative method, the residual r^{k} may converge to zero sooner. The rate of convergence for both CG and CGF depends on the condition number cond(A), even though there is no explicit use of matrix A in CGF. The smaller the condition number is, the fast the convergence is. If cond(A)=1, both CG and CGF converges in one iteration.

The basis functions {φ₀(x), . . . ,φ_{M-1}(x)} may be orthogonalized by, for example, the Gram-Schmidt process. Let {ψ₀(x), . . . ,ψ_{M-1}(x)} be orthonormal basis obtained from the orthogonalization of {φ₀(x), . . . ,φ_{M-1}(x)}, i.e.,

$${ψ}_{k} ( x ) ∈ span \{ {φ}_{0} ( x ) , … , {φ}_{k} ( x ) \} , k = 0 , 1 , … , M - 1 , \\ 〈 {ψ}_{i} ( x ) , {ψ}_{j} ( x ) 〉 = \{ \begin{matrix}0 & i \neq j \\ 1 & i = j .\end{matrix}$$

For polynomials where {φ₀(x),φ₁(x) . . . ,φ_{M-1}(x)}={1,x, . . . ,x^{M-1}}, the orthonormal basis {ψ₀(x), . . . ,ψ_{M-1}(x)} can be constructed in a simpler way than the Gram-Schmidt by using a three term recursion:

a= [symbol] x\hat{ψ}ₖ(x),\hat{ψ}ₖ(x) [symbol] / [symbol] \hat{ψ}ₖ(x),\hat{ψ}ₖ(x)

[symbol]

b= [symbol] \hat{ψ}ₖ(x),\hat{ψ}ₖ(x) [symbol] / [symbol] \hat{ψ}ₖ₋₁(x),\hat{ψ}ₖ₋₁(x)

[symbol]

\hat{ψ}ₖ₊₁(x)=(x−a)\hat{ψ}ₖ(x)−b\hat{ψ}ₖ₋₁(x)

ψₖ₊₁(x)=\hat{ψ}ₖ₊₁(x)/∥\hat{ψ}ₖ₊₁(x)∥

With an othonormal basis, the normal matrix has condition number cond(A)=cond(A(ψ))=1.

It seems that orthogonalization is expensive and it defeats the purpose of the CG method in the first place. After all, with the orthonormal basis, the least squares solution can be computed easily without going through the CG iterations (it equals to the right-hand-side of the normal equations). In many applications, however, this is not the case. First, the cost of computing and storing the orthonormal basis {ψ₀(x), . . . ,ψ_{M-1}(x)} is negligible in many applications. If the random process Y(t) is stationary, the p.d.f. ρ does not vary with time. The orthogonalization can be performed only once at the beginning of the iterations. No additional computation is needed in the iterations. Even in the applications where ρ may vary with time, the probability density functions can usually be determined by such parameters their means and variances. Also, in many applications, the original basis functions {φ₀(x), . . . ,φ_{M-1}(x)} are usually stored, e.g., in the form of look-up tables, and these same storage can be used to store the {ψ₀(x), . . . ,ψ_{M-1}(x)} in the orthogonalization process. Therefore, no additional storage is needed for the orthonormal basis. Secondly, even if the orthonormal basis is found, the iteration will not terminate after one iteration in practice, as we will see in below. This is because one is not able to compute some inner products in the CGF algorithm, and some approximation of the inner products must be made to form computable inner products. In terms of the computable inner products, the basis functions {ψ₀(x), . . . ,φ_{M-1}(x)} may no longer be orthogonal, and therefore, the solution cannot be obtained with one iteration.

### The Stochastic Conjugate Gradient Method

Although Algorithm CGF produces exact solution to Problem 1 in at most M iterations, it cannot be realized if the function g(x) to be approximated is not known explicitly. This is because the computation of γ^{k}=[γ₀^{k}, . . . ,γ_{M-1}^{k}]^{T} involves the inner product of g(x). Therefore, these inner products need to be approximated.

Let {z₀,z₁, . . . ,z_{N-1}}, and {y₀,y₁, . . .,y_{N-1}}, n=0,1, . . . ,N−1, be samples from the random processes Z(t) and Y(t), respectively. By the definition of Z(t), zₙ=g(yₙ), n=0,1, . . . ,N−1. The inner products of any two functions is given by

$$〈 u ( x ) , v ( x ) 〉 = {\int }_{0}^{1} ρ ( x ) {u ( x )}^{*} v ( x ) d x = E ( {u ( Y )}^{*} v ( Y ) ) \cdot \qquad ( 8 )$$

Evaluating the functions u(x), v(x) at the samples {y₀,y₁, . . . ,y_{N-1}}, and defining

u(y)=[u(y₀),u(y₁), . . . ,u(y_{N-1})]^{T}

v(y)=[v(y₀),v(y₁), . . . ,v(y_{N-1})]^{T} (9)

we have

$$〈 u ( x ) , v ( x ) 〉 = E ( {u ( Y )}^{*} v ( Y ) ) = {lim}_{N \to ∞} \frac{1}{N} {u ( y )}^{H} v ( y ) . \qquad ( 10 )$$

Therefore, the inner product [symbol] u(x),v(x) [symbol] can be approximated by

$$\frac{1}{N} {u ( y )}^{H} v ( y ) .$$

$$〈 u ( x ) , v ( x ) 〉 \approx \frac{1}{N} {u ( y )}^{H} v ( y ) = \frac{1}{N} {\sum }_{n = 0}^{N - 1} {u ( {y}_{n} )}^{*} v ( {y}_{n} ) . \qquad ( 11 )$$

We define

$${〈 u ( x ) , v ( x ) 〉}_{s} {=}^{Δ} \frac{1}{N} {\sum }_{n = 0}^{N - 1} {u ( {y}_{n} )}^{*} v ( {y}_{n} ) . \qquad ( 12 )$$

Strictly speaking, [symbol] u(x),v(x) [symbol] ₛ is not an inner product because the support of u(x),v(x) may not intersect the samples {y₀,y₁, . . .,y_{N-1}}. In addition, [symbol] u(x),v(x) [symbol] ₛ depends on the particular instance of samples.

In general, an orthonormal basis {ψ₀(x), . . . ,ψ_{M-1}(x)} in [symbol] •,• [symbol] is no longer orthogonal in [symbol] •,• [symbol] ₛ.

In applications where the probability density function ρ(x) is difficult to estimate, all inner products [symbol] •,• [symbol] in CG or CGF can be replaced by [symbol] •,• [symbol] ₛ. However, it is more advantageous to use [symbol] •,• [symbol] even when an estimate of ρ(x) may not be very accurate. This is because [symbol] •,• [symbol] does not depend on the observed samples, and therefore, they don't change from iteration to iteration. This helps to keep the orthogonality of the direction functions in the CGF algorithm.

In practical implementations, the inner products that do not involve the unknown function g(x) can be approximated as follows.

$$〈 u ( x ) , v ( x ) 〉 \approx \frac{1}{B} {\sum }_{n = 0}^{B - 1} ρ ( \frac{n}{B} ) {u ( \frac{n}{B} )}^{*} v ( \frac{n}{B} ) , \\ for some integer B . \qquad ( 13 )$$

Note that equation (13) does not depend on samples from observation. Unlike [symbol] •,• [symbol] ₛ, the right hand side of (13) does define an inner product for certain function spaces if B is large enough. For example it is an inner product for the polynomials of degree less than M if B≧M.

After the approximation of the inner products, the CG algorithms will in general no longer terminate after a finite number of iterations due to the loss of orthogonality among the search directions v. Therefore, there is a need to restart the process, i.e., reset the search direction v to the residual, from time to time. For example, one can choose a predetermined positive integer, and restart the process after the given number of iterations have been performed.

The following algorithm is derived from CG by replacing the inner product [symbol] •,• [symbol] by [symbol] •,• [symbol] ₛ in equation (6). In addition, the initial step is rearranged so that the residual is calculated first at each iteraton.

Algorithm SCG

At start:

Given threshold ε > 0
Given basis functions {ψ₀(x), . . . , ψ_{M-1}(x)}, which need not be
orthonormal
Compute the covariance matrix A in equation (5)
Determine a strategy to reset the search direction at least once every

M iterations

u = 0;

Loop

Take samples {y₀, y₁, . . . , y_{N-1}}, {z₀, z₁, . . . , zₙ₋₁} such that
$\begin{matrix}{z}_{n} = g ( {y}_{n} ) , n = 0 , 1 , … , N - 1 \\ {γ}_{i} = {〈 {ψ}_{i} ( x ) , g ( x ) - {\sum }_{i = 0}^{N - 1} {u}_{i} {ψ}_{i} ( x ) 〉}_{s} = \frac{1}{N} {\sum }_{n = 0}^{N - 1} {{ψ}_{i} ( {y}_{n} )}^{*} ( {z}_{n} - {\sum }_{i = 0}^{N - 1} {u}_{i} {ψ}_{i} ( {y}_{n} ) ) , \\ i = 0 , … , M - 1 \\ r = {[ {γ}_{0} , … , {γ}_{N - 1} ]}^{T}\end{matrix}$
if at start, or reset

v = r

else

$\begin{matrix}β = \frac{{r}^{H} r}{ω} \\ ω = {r}^{H} r \\ v ← r + βv\end{matrix}$

end
if ω < ε

reset at the next iteration

else

$\begin{matrix}α = \frac{ω}{{v}^{H} Av} \\ u ← u + αv\end{matrix}$

end

end loop

Note that in SCG, the covariance matrix is computed only once at the start of the algorithm. This is because the covariance matrix is given in terms of the inner products [symbol] •,• [symbol] . If these inner products cannot be practically computed, as in the multivariate function approximations, they must be replaced by [symbol] •,• [symbol] ₛ and the computation of the covariance matrix must be done within the loop. Consequently, the covariance matrix needs to be computed once at each iteration, and the complexity becomes O(M²) per iteration. The details on the complexity of the algorithm will be given below. On the contrary, the following algorithm has the same complexity of O(M) per iteration whether [symbol] •,• [symbol] or [symbol] •,• [symbol] ₛ is used.

Algorithm SCGF

At start:

Given ε > 0, and the basis functions {ψ₀(x), . . . , ψ_{M-1}(x)}, which

need not be orthonormal

Determine a strategy to reset the search direction at least once every

M iterations

u(x) = 0

loop:

Take samples {y₀, y₁, . . . , y_{N-1}}, {z₀, z₁, . . . , z_{N-1}} such that
$\begin{matrix}{z}_{n} = g ( {y}_{n} ) , n = 0 , 1 , … , N - 1 \\ {γ}_{i} = {〈 {ψ}_{i} ( x ) , g ( x ) - u ( x ) 〉}_{s} = \frac{1}{N} {\sum }_{n = 0}^{N - 1} {{ψ}_{i} ( {y}_{n} )}^{*} ( {z}_{n} - u ( {y}_{n} ) ) , \\ i = 0 , … , M - 1 \\ r = {[ {γ}_{0} , … , {γ}_{M - 1} ]}^{T}\end{matrix}$
if at start, or reset

$v ( x ) = {\sum }_{i = 0}^{M - 1} {γ}_{i} {ψ}_{i} ( x )$

else

$\begin{matrix}β = \frac{{r}^{H} r}{ω} \\ ω = {r}^{H} r\end{matrix}$
$v ( x ) ← {\sum }_{i = 0}^{M - 1} {γ}_{i} {ψ}_{i} ( x ) + β v ( x )$

end
if ω < ε

reset at the next iteration

else

$\begin{matrix}α = \frac{ω}{〈 v ( x ) , v ( x ) 〉} \\ u ( x ) ← u ( x ) + α v ( x )\end{matrix}$

end

end loop

u(x) is an approximation of the solution to Problem 1. Due to the approximation of the inner products involving the function g(x), it is not expected that r will be zero after any finite number of iterations if the samples are different from iteration to iteration. Because samples are used to compute some inner products [symbol] •,• [symbol] in the algorithm, it is called stochastic CG.

Algorithms SCG and SCGF have no stopping criteria; it provides approximation of g(x) continuously. At each iteration, a number of samples are taken. The sample size, N, may be different from iteration to iteration. It is also possible that the same samples are used from the previous iteration. This corresponds to performing more than one iteration of SCG with the same covariance matrix. If the same sets of samples are kept unchanged for M iterations, the residual is guaranteed to be zeros in no more than M iterations, although the resulting function u(x) may still not be the solution to Problem 1.

One can also apply the sliding window strategy similar to that proposed in [2]. Namely, at each iteration, some number of samples are taken and are added into the sample set {y₀,y₁, . . . ,y_{N-1}}. At the same time, the older samples from the set are removed so that the set has the same total number of samples from iteration to iteration.

Comparing Algorithm SCGF to Algorithm CGF, the only difference is the replacement of [symbol] •,• [symbol] in CGF by [symbol] •,• [symbol] ₛ. According to (10), if the sample size in SCGF is large enough, Algorithm SCGF behaves similarly as Algorithm CGF. This suggests that there is an advantage in taking a large number of samples in SCGF. The larger the sample size N is, the closer [symbol] •,• [symbol] ₛ is to [symbol] •,• [symbol] . This helps to maintain the orthogonality among the directional functions in the SCGF.

The comparison of the complexity of SCG and SCGF will be given below.

### Additional Implementation Considerations

In applications, the computed function u(x) is used in further processing by other modules. In hardware implementation such as on an FPGA, the evaluation of a function is best accomplished by the use of a look-up table (LUT). A LUT of a function is a vector whose index corresponds to a quantized value of the independent variable of the function. Therefore, the function u(x), the basis functions {φ₀(x), . . . ,φ_{M-1}(x)}, or {ψ₀(x), . . . ,ψ_{M-1}(x)}; and other functions in the SCG algorithm can be represented by LUTs.

Quantize [0,1] into B levels, and let

$${x}_{k} = \frac{k}{B} ,$$

k=0, . . . , B−1. Then the look-up table representation can be defined as

LUTu(k)=u(xₖ), k=0, . . . , B−1.

To evaluate a function represented by a LUT at a value y ε [0,1], the value y is first quantized to produce an index. The value of the function is approximated by the table value at the given index as

$$u ( y ) \approx LUTu ( round ( ( B - 1 ) y ) ) = u ( \frac{round ( ( B - 1 ) y )}{B - 1} ) , y ∈ [ 0 , 1 ] ,$$

where round(y) is the nearest integer of y.

### Estimate for the Probability Density Function

The probability density function ρ(x) of the random process Y(t) plays an important role in the SCG and SCGF. Theoretically, the solution to the normal equations (4) is the solution to Problem 1 if and only if the weight function in the inner product is the same the probability density function ρ(x). Although one could theoretically use another inner product to define Problem 1, both SCG and SCGF are derived based on the assumption that [symbol] •,• [symbol] ₛ is a good approximation of [symbol] •,• [symbol] , which is the case only when the probability density function ρ(x) is used as the weight function. Practically, as we pointed out previously, in order to reduce condition number of the covariance matrix, and hence increase the convergence rate of SCG and SCGF, the orthogonalization of the basis functions is helpful. Even though the covariance matrix is not explicitly used in SCGF algorithm, the convergence of the algorithm is still dependent on its condition number. The orthogonalization process requires the knowledge of the probability density function ρ(x). It is therefore important to have a way to estimate β(x).

In the application of linearization of power amplifiers, the signal is usually an OFDM signal. The amplitude of an OFDM signal has a probability distribution close to the Rayleigh distribution, and therefore, we may choose

$$ρ ( x ) = \frac{x}{{σ}^{2}} {e}^{- {x}^{2} / ( 2 {σ}^{2} )} .$$

The parameter σ may be estimated from observed samples by

$$\hat{σ} = \sqrt{\frac{1}{2 N} {\sum }_{n = 0}^{N - 1} {y}_{n}^{2}} .$$

In general, a histogram or the kernel density estimation may be used to estimate the probability density function. The estimated probability density function can be represented by a LUT.

With the LUT representations, an inner product not involving g(t) can be approximated by

$$〈 u ( x ) , v ( x ) 〉 \approx \frac{1}{B} {\sum }_{n = 0}^{B - 1} ρ ( \frac{n}{B} ) {u ( \frac{n}{B} )}^{*} v ( \frac{n}{B} ) = \frac{1}{B} {\sum }_{n = 0}^{B - 1} {LUT}_{ρ} ( n ) {{LUT}_{u} ( n )}^{*} {LUT}_{v} ( n )$$

We define

$$〈 LUTu , LUTv 〉 = \frac{1}{B} {\sum }_{n = 0}^{B - 1} {LUT}_{ρ} ( n ) {{LUT}_{u} ( n )}^{*} {LUT}_{v} ( n )$$

Algorithm SCG_LUT

At start:

Given ε > 0 and integer B > 0, and basis function {LUTφ₀, . . . ,
LUTφ_{M-1}}
Take samples {y₀, y₁, . . . , y_{N-1}}, {z₀, z₁, . . . , z_{N-1}} such that
zₙ = g(yₙ), n = 0, 1, . . . , N − 1
Estimate ρ(x) with LUT representation LUTρ
Perform orthogonalization on {LUTφ₀, . . . , LUTφ_{M-1}} to get
orthonormal basis
{LUTψ₀, . . . , LUTψ_{M-1}}
Determine a strategy to reset the search direction at least once every

M iterations

LUTu = 0

loop:

Take samples {y₀, y₁, . . . , y_{N-1}}, {z₀, z₁, . . . , z_{N-1}} such that
zₙ = g(yₙ), n = 0, 1, . . . , N − 1 (N may be different from iteration to
iteration)
$\begin{matrix}{γ}_{i} = \frac{1}{N} {\sum }_{n = 0}^{N - 1} LUT {{ψ}_{i} ( round ( ( B - 1 ) {y}_{n} ) )}^{*} \\ ( {z}_{n} - LUTu ( round ( ( B - 1 ) {y}_{n} ) ) ) \\ r = {[ {γ}_{0} , … , {γ}_{M - 1} ]}^{T}\end{matrix}$
if at start, or reset

$LUTv = {\sum }_{i = 0}^{M - 1} {γ}_{i} LUT {ψ}_{i}$

else

$\begin{matrix}β = \frac{{r}^{H} r}{ω} \\ ω = {r}^{H} r\end{matrix}$
$LUTv ← {\sum }_{i = 0}^{M - 1} {γ}_{i} LUT {ψ}_{i} + β LUTv$

end
if ω < ε

reset at the next iteration

else

$\begin{matrix}α = \frac{ω}{〈 LUTv , LUTv 〉} \\ LUTu ← LUTu + α LUTv\end{matrix}$

end

end loop

The steps of estimating the probability density function and the orthogonalization may be repeated periodically to improve performance. Similarly to SCGF, the inner products [symbol] •,• [symbol] in SCG_LUT may be evaluated by samples, and hence replaced by [symbol] •,• [symbol] ₛ.

### The Complexity of SCG and SCGF

With a specific implementation of the SCGF algorithm as in SCG_LUT, we are able to make a definite comparison between the complexity of the SCG and SCGF. We are concerned with the complexity within the loop only, and will neglect the operations that are only needed once at the start.

We start with SCG. To form the residual, the approximating function is computed first at the samples, which requires the linear combination of the basis functions, and hence MF operations, where F means function operations. When the functions are implemented by look up tables, a function has B entries to compute, and therefore, MF=MB. Strictly as the SCG algorithm is concerned, the functions are only evaluated at the sample locations, so the number of operations is MN where N is the number of samples. However, the end goal of the SCG is to produce a function to be used for other purposes, and therefore, there is always a need to form the approximating function. Thus, the actual total process of evaluating the function is to first form the function, with MB operations, and then evaluate the function with N operations. This gives MB+N. After the residual is computed, M inner products [symbol] •,• [symbol] ₛ are computed, which requires MN operations (there are, in fact, MN sums and MN products, but we omit that level of details). The rest of operations are on vectors of size M, and we count them as O(M). Therefore, the total operational counts for each iteration of SCG is

O(MN+MB+N+M) (14)

The complexity in (14) is assuming that the covariance matrix A is computed by using [symbol] •,• [symbol] once at the start of the process, and never computed again. However, when [symbol] •,• [symbol] ₛ must be used for computing the normal matrix A, as in the case for multivariate functions (see section below), it must computed at each iteration with new samples, and therefore, this requires an additional

$$\frac{M ( M + 1 )}{2}$$

inner product computations, and therefore, the total operations per iteration becomes

O(M²N+MN+MB+N+M) (15)

Next, we find the complexity for SCG_LUT. To form the residual, the LUT values are evaluated at the samples, which represents N operations. Then M inner products [symbol] •,• [symbol] ₛ are computed, which requires MN operations. Finally, the residual is formed with M basis functions, to give MB operations. The rest of the operations require one inner product [symbol] •,• [symbol] , and 2 function updates. The inner products can be computed either using (12) or (13), which requires N or B operations, respectively.

Each function update requires updating B entries of the LUT, and therefore, requires B operations. There is also the operation of vector product r^{H}r which has M operations. The complexity for SCG_LUT is therefore,

O(MN+MB+N+B+M) (16)

The comparison of (16) with (14) shows that the complexity of SCGF is actually quite comparable to that of SCG even when the covariance matrix is not computed at each iteration. However, as compared to (15), the SCGF has smaller complexity when the covariance matrix must be re-computed at each iteration.

The SCGF algorithm does require additional storage, namely, the storage for one additional intermediate function, v. With the LUT implementation, this represents the memory requirement of B complex numbers. (SCG also needs storage of O(M²) complex numbers for the covariance matrix, but that may be neglected).

### Multivariate Functions

Although the theoretical treatment for multivariate functions is very close to that for functions of one variable, there are significant practical issues in multivariate functions that warrant more discussions.

Problem 1, Algorithm CGF and Algorithm SCGF are all valid for multivariate functions, if one replaces the functions of one variable by multivariate functions in them. However, it is no longer feasible to compute the inner products [symbol] •,• [symbol] . Their computation not only requires multivariate integrals, but also requires knowledge of the joint probability density function ρ(Y¹,Y¹, . . . ,Y^{Q}), both of which may not be practical due to the curse of dimensionality. Therefore all inner products <•,•> need to be replaced by the sample-evaluated version [symbol] •,• [symbol] ₛ, where

$${〈 u , v 〉}_{s} {=}^{Δ} \frac{1}{N} {\sum }_{n = 0}^{N - 1} {u ( {y}_{n}^{1} , {y}_{n}^{2} , … , {y}_{n}^{Q} )}^{*} v ( {y}_{n}^{1} , {y}_{n}^{2} , … , {y}_{n}^{Q} ) .$$

Let us consider a special case of additive separable functions in which the multivariate function is a sum of functions of one variable. Such problems arise in many applications. In the linearization of high power amplifiers with memory effects [3], the inverse function of a power amplifier is to be approximated by an additive separable function, in which each dimension represents a shift in the sample delay of the time sequence of samples. The delay in samples is necessary to account for the memory effects of the HPA. In [4], approximation of multivariate functions is reduced to a series of problems of finding the best additive separable function approximation.

Let g(x¹,x², . . . ,x^{Q}) be a complex valued function of complex variables. Let Y¹,Y², . . . ,Y^{Q} be complex valued random processes. Each of |Y^{q}| has the probability density function ρ(x)>0 and

$${\int }_{0}^{1} ρ ( x ) d x = 1.$$

Let Z=g(Y¹,Y², . . . ,Y^{Q}). Let {ψ₀(|x|), . . . ,ψ_{M-1}(|x|)} be a set of linearly independent complex valued functions of one real variable defined on the interval [0,1]. Let {τ₁(x), . . . ,τ_{Q}(x)} be a given set of complex valued functions of one complex variable. In the linearization of high power amplifiers [3], these functions are τ_{q}(x)=x,q=1, . . . ,Q. Define Y=[Y¹,Y², . . . ,Y^{Q}], and let |x| be the amplitude of the complex variable x. We are now interested in the following best approximation problem.

$$Problem 2$$

$$Find , {u}^{q} ( \vert x \vert ) = {\sum }_{i = 0}^{M - 1} {u}_{i}^{q} {ψ}_{i} ( \vert x \vert ) , \\ q = 1 , … , Q such that$$

$$E ( {( g ( Y ) - {\sum }_{q = 1}^{Q} {τ}_{q} ( {Y}^{q} ) {u}^{q} ( \vert {Y}^{q} \vert ) )}^{*} ( g ( Y ) - {\sum }_{q = 1}^{Q} {τ}_{q} ( {Y}^{q} ) {u}^{q} ( \vert {Y}^{q} \vert ) ) ) = E ( {( Z - {\sum }_{q = 1}^{Q} {τ}_{q} ( {Y}^{q} ) {\sum }_{i = 0}^{M - 1} {u}_{i}^{q} {ψ}_{i} ( \vert {Y}^{q} \vert ) )}^{*} ( Z - {\sum }_{q = 1}^{Q} {τ}_{q} ( {Y}^{q} ) {\sum }_{i = 0}^{M - 1} {u}_{i}^{q} {ψ}_{i} ( \vert {Y}^{q} \vert ) ) ) = {min}_{{v}^{q} ∈ span \{ {ψ}_{0} , {ψ}_{1} … , {ψ}_{M - 1} \}} E ( {( Z - {\sum }_{q = 1}^{Q} {τ}_{q} ( {Y}^{q} ) {v}^{q} ( \vert {Y}^{q} \vert ) )}^{*} ( Z - {\sum }_{q = 1}^{Q} {τ}_{q} ( {Y}^{q} ) {v}^{q} ( \vert {Y}^{q} \vert ) ) )$$

The approximation of the solutions u¹(|x|), q=1, . . . ,Q can be computed using the following algorithm.

Algorithm SCG_MUL

At start:

Given ε > 0, and the basis functions {ψ₀(|x|), . . . , ψ_{M-1}(|x|)},

which need not be orthonormal

Determine a strategy to reset the search direction at least once every

M iterations

u^{q}(x) = 0, for q = 1, . . . , Q

loop:

Take samples {y₀^{q}, y₁^{q}, . . . , y_{N-1}^{q}}, q = 1, . . . , Q,
{z₀, z₁, . . . , z_{N-1}} such that
zₙ = g(yₙ¹, . . . , yₙ^{Q}), n = 0, 1, . . . , N − 1
r = [γ₀, . . . , γ_{M-1}]^{T}
for q = 1, . . . , Q

$\begin{matrix}{γ}_{i}^{q} = \frac{1}{N} {\sum }_{n = 0}^{N - 1} {( {τ}_{q} ( {y}_{n}^{q} ) {ψ}_{i} ( \vert {y}_{n}^{q} \vert ) )}^{*} ( {z}_{n} - {\sum }_{q = 1}^{Q} {τ}_{q} ( {y}_{n}^{q} ) {u}^{q} ( \vert {y}_{n}^{q} \vert ) ) \\ {r}^{q} = {[ {γ}_{0}^{q} , … , {γ}_{M - 1}^{q} ]}^{T}\end{matrix}$

endfor
if at start or reset

for q = 1, . . . , Q

${v}^{q} ( \vert x \vert ) = {\sum }_{i = 0}^{M - 1} {γ}_{i}^{q} {ψ}_{i} ( \vert x \vert )$

endfor

else

$β = \frac{{\sum }_{q = 1}^{Q} {( {r}^{q} )}^{H} {r}^{q}}{ω}$
$ω = {\sum }_{q = 1}^{Q} {( {r}^{q} )}^{H} {r}^{q}$
for q = 1, . . . , Q

${v}^{q} ( \vert x \vert ) ← {\sum }_{i = 0}^{M - 1} {γ}_{i}^{q} {ψ}_{i} ( \vert x \vert ) + β {v}^{q} ( \vert x \vert )$

endfor

end
if ω < ε

reset at the next iteration

else

$λ = {\sum }_{n = 0}^{N - 1} {\vert {\sum }_{q = 1}^{Q} {τ}_{q} ( {y}_{n}^{q} ) {v}^{q} ( \vert {y}_{n}^{q} \vert ) \vert}^{2}$
$α = \frac{ω}{λ}$
for q = 1, . . . , Q

u^{q}(|x|) ← u^{q}(|x|) + αv^{q}(|x|)

endfor

end

end loop

The complexity of SCG_MUL is linear with the number of dimensions, Q, and it can be obtained by multiplying (16) by Q

O(MNQ+MBQ+NQ+BQ). (17)

However, if the SCG is applied to Problem 2, the covariance matrix would have the dimension QM×QM, and it must be computed at each iteration. Therefore, the complexity of the SCG applied to Problem 2 is

O(M²Q²N+MNQ+MBQ+NQ+MQ), (18)

which is much higher than (17).

Although the same number of basis functions are used in SCG_MUL for each dimension q=1, . . . ,Q, it is purely for convenience, and it is not necessary. The number of basis functions can be different for different q, and it can be controlled in the steps of computing γᵢ^{q} and r^{q}. Furthermore, the basis functions themselves could be different for different dimension q.

It is also advantageous to use the orthonormal basis functions {ψ₀, . . . ,ψ_{M-1}}, because it helps to reduce the condition number of the normal equations. In Problem 2, the orthonormal basis functions are defined as

$$〈 {τ}_{q} ( x ) {ψ}_{i} ( \vert x \vert ) , {τ}_{q} ( x ) {ψ}_{j} ( \vert x \vert ) 〉 = \{ \begin{matrix}0 & i \neq j , q = 1 , … , Q \\ 1 & i = j , q = 1 , … , Q\end{matrix}$$

Even if {ψ₀, . . . ,ψ_{M-1}} is an orthonormal basis, and each dimension uses the same basis functions, the condition number of the normal equations for the multivariate Problem 2 is still larger than 1 in general. This is because the covariance matrix for the multivariate problem may not be diagonal since the dimensional variables are not necessarily independent random variables. However, experiments show that using the orthonormal basis functions for each dimension will reduce the conditional number of the covariance matrix for the multivariate problem.

### Simulations

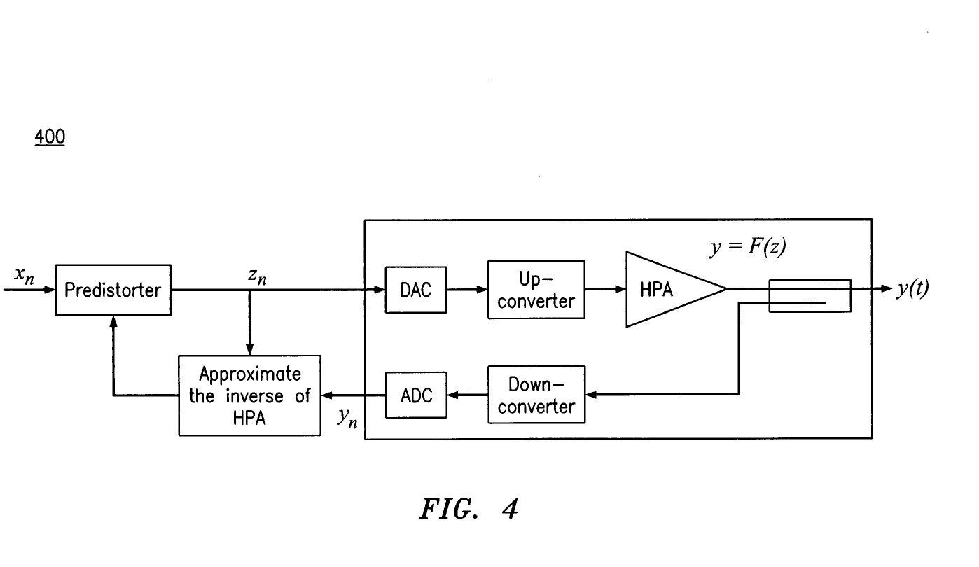

We will apply the SCG_MUL algorithm to the predistortion for linearization of high power amplifiers as studied in [5]. In [5], memory polynomials are used as the predistorter and the computation of the predistorter amounts to solving the approximation Problem 2, in which the basis functions are polynomials. A block diagram 100 of the polynomial predistortion is shown in FIG. 1. Similar embodiments are depicted in diagram 400 of FIG. 4.

In a polynomial predistorter, the signal is predistorted by a polynomial. The signal after predistortion is converted to an analog signal and transmitted to the high power amplifier (HPA). A feedback signal from the HPA is sampled, and the pair yₙ,zₙ form the samples from the observation. The objective is to approximate the inverse of the HPA transfer function. If yₙ is considered the input, and zₙ the output, then they are the samples from the observation of the function to be approximated. The polynomial that best approximates the inverse transfer is computed, and it is used as a predistorter to form zₙ from xₙ.

The process is iterative. A set of data yₙ,zₙ is captured. The best approximating polynomial is computed, and the resulting polynomial is used as the predistorter, and a new set of data is then captured. We call this the outer loop. At each iteration of the outer loop, we perform the SCG_MUL algorithm to find the approximating polynomial. As explained previously, for each set of captured data, the SCG_MUL algorithm can be performed either one iteration, or multiple iterations. In case that multiple iterations are performed, the SCG_MUL iterations form an inner loop.

In our simulations, we use the memory polynomial PA model as given in Example 2 of [5]. The memory polynomials of degree 5 with 3 taps are used as the predistorter. That is, the parameters of Problem 2 are given by M=5, Q=3. As was suggested by [5], this choice of parameters results in good performance for the distortion with the given PA model.

An OFDM signal with 16 QAM modulation is used in our simulations. At the beginning of each simulation, 25,600 samples are captured for each of yₙ,zₙ. These samples are used to estimate the probability density function ρ(x) using the histogram method. The orthogonal polynomial basis {ψ₀(|x|), . . . ,ψ_{M-1}(|x|)} is then formed using the three term recursion. These functions are represented by LUTs of 12 bits, i.e., B=4096. In each data capture of the SCG_MUL algorithm, a total of 1280 samples are taken for each of yₙ,zₙ. That is, N=1280 was used in the simulations.

We ran four simulations using SCG_MUL algorithm, and they are named Sim1, Sim2 and Sim3 and Sim4. In Sim1, we ran the algorithm with the maximum number of iterations per set of samples captured, i.e., MQ=15 iterations are performed for each data captured. The solution at the last iteration corresponds to the solution from a direct method applied to the normal equations with the inner products formed with the given set of the samples. In Sim2, only one iteration is performed for each set of samples captured. In both Sim1 and Sim2, the weight function used for the orthogonalization of the basis functions is the estimated probability density function. Sim3 is similar to Sim2, but the weight function is the uniform distribution (that is, no weight function is used in the orthgonalization process). Sim4 is similar to Sim2. However, a sliding widow is used for the captured samples. The total number of data used is 4N=5120. As in other simulations, N=1280 samples are captured at each iteration. These samples are added to the total data set, but the earliest N=1280 samples are removed from the data set. The parameters used in the simulations are summarized in the following table:

| Simulations | SCG | Weight | Sliding |
|---|---|---|---|
| name | iterations | function | widow |
| Sim1 | 15 | Estimated | 1N |
| | | PDF | |
| Sim2 | 1 | Estimated | 1N |
| | | PDF | |
| Sim3 | 1 | Uniform | 1N |
| | | distribution | |
| Sim4 | 1 | Estimated | 4N |
| | | PDF | |

In all the simulations, the search direction v is reset after every MQ=15 iterations. In Sim1, the reset is performed every time a new set of samples are taken. In all simulations, after the computations are completed, and a new approximation u is available in each SCG iteration, the newly computed u is immediately used in the outer loop. That is, after each SCG iteration in both configurations, the computed approximating polynomial is immediately used as the predistorter shown in diagram 100.

In each simulation, a total of 210 SCG iterations are performed. In Sim1, a total of 14 data captures were performed (there are 15 SCG iterations for each data capture), and 210 data captures were performed in other simulations. At the end of the simulation, the PA output signal yₙ is almost identical to the original signal xₙ.

To show the performance of the SCG_MUL algorithm, we examine the residual computed at the beginning of each iteration. Let yₙ,zₙ be the set of the captured samples. Let P be the computed polynomial from the previous iteration. Then the normalized residual is defined as

$$r = \frac{‖ {z}_{n} - P ( {y}_{n} ) ‖}{‖ {z}_{n} ‖} .$$

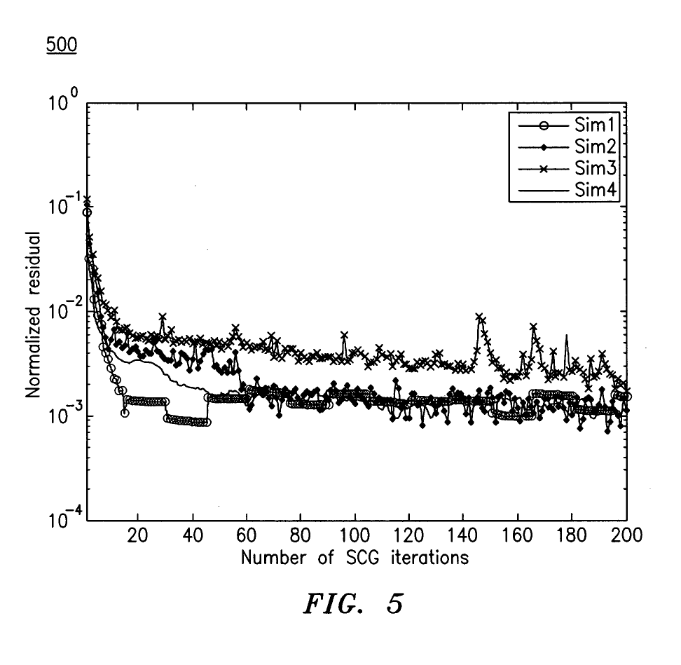

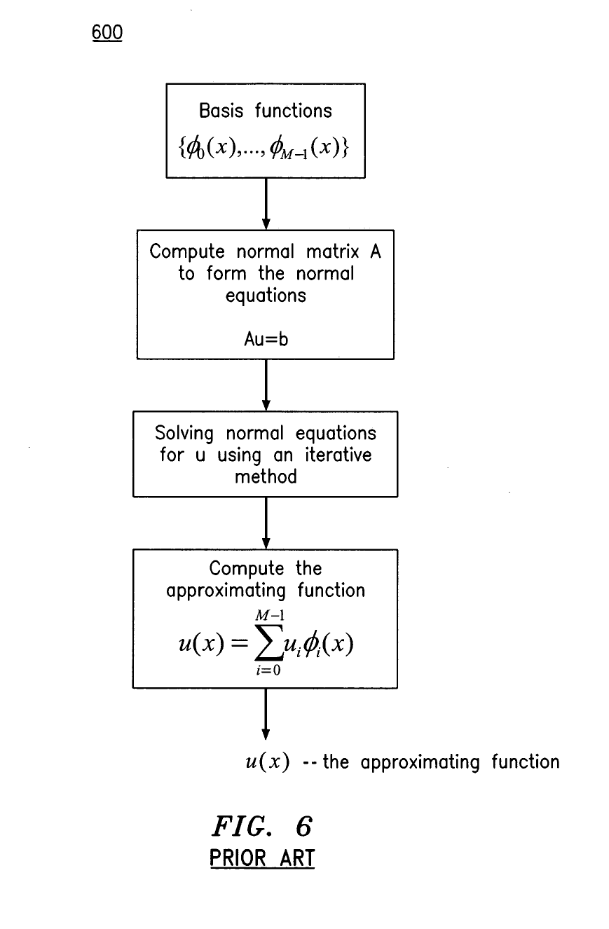

The normalized residuals at each SCG iteration are shown in the graphical depiction 500 of FIG. 5.

We can make the following observations. First, as expected, in Sim1, a fairly accurate solution is obtained in 15 SCG iterations. After that, the residual does not change significantly. The variation in the residuals after 15 SCG iterations is mainly due to the fact that they are computed with different sets of samples. The number of samples used in the simulations is fairly small. The residual remains almost constant during the 15 SCG iterations when the same set of samples is used. This reinforces the point that after some initial time, there is no need to perform more iterations in the SCG using the same set of captured samples. One reason for the residual to be prohibited from being further reduced is the noise present in the signal. Even in the absence of the noise, the residual will have a nonzero lower bound because the inverse of the PA transfer function may not be in the space of the basis functions. That is, the best approximation formed with the basis functions, the solution to the normal equations, may not equal to the function to be approximated.

In Sim2, the first 5 or 6 iterations are almost identical to those in Sim1. After that, the convergence slows down. Again, this is expected because the SCG algorithm loses orthogonality when different samples are taken at different iterations. However, the normalized residuals are reduced to the similar level as in Sim1 after about 60 SCG iterations (which is equivalent to 4 data captures in Sim1). There seems to be more jitters in the residuals for Sim2, but that is because each SCG iteration uses a different set of captured data, and hence the residual differs significantly from iteration to iteration. On the contrary, in Sim1, the same set of data is used in 15 iterations, and hence the residual remains smooth for that duration. Overall, the variation in the residual from one data capture to another is about the same in both Sim1 and Sim2.

In Sim3, we see that the convergence of the SCG is significantly slower when the uniform distribution is used as the weight function in the orthogonal basis. This is due to the fact that the condition number of the covariance matrix is larger when the weight function is not equal to the probability density function of the samples.

Sim4 shows that it is advantageous to use a sliding window. First, the convergence rate is faster as compared to Sim2. This is due to the fact that the data set has correlations from one iteration to another, and therefore, the convergence behaves like that of Sim1 in which data set does not change from iteration to iteration. Secondly, the variation in the residual is also smaller.

### Conclusions

A stochastic conjugate gradient method has been described herein, Algorithm SCGF, in which the approximating function is computed directly without using the covariance matrix. This reduces complexity of the computation in many applications. The SCGF algorithm is suitable for implementation on hardware such as FPGA or ASIC. From Algorithm SCGF, other variants can be derived for specific applications, algorithm SCG_LUT and SCG_MUL are two examples.

Although the probability density function of the observed samples may not be used directly by the SCGF algorithms (for example, when the inner products are computed by sample evaluations), it is still advantageous to estimate the probability density function to form orthonormal basis functions. The use of the orthonormal basis helps to reduce the condition number of the covariance matrix, and therefore, helps to increase the convergence of the SCGF algorithm. Also, the use of a sliding window in the data set is advantageous for speeding up the convergence and for smoother residual.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for approximating a function comprising:
utilizing a stochastic conjugate gradient method (SCG) to iteratively compute a first approximating function using a set of basis functions;
using the first approximating function in the generation of output data;
compute a second approximating function using the output data.

2. The method as recited in claim 1, wherein utilizing an SCG to iteratively compute the first approximating function comprises
utilizing an SCG for multivariate functions to iteratively compute the first approximating function.

3. The method as recited in claim 1, wherein utilizing an SCG to iteratively compute the first approximating function comprises
utilizing a stochastic conjugate gradient method on functions (SCGF) to iteratively compute the first approximating function

4. The method as recited in claim 3, wherein utilizing an SCGF to iteratively compute the first approximating function comprises
utilizing an SCGF for multivariate functions to iteratively compute the first approximating function.

5. A method for approximating a function comprising:
utilizing a stochastic conjugate gradient method (SCG) to compute a first approximating function using a set of basis functions and a first set of input data and a first set of output data;
generating a second set of output data using the first approximating function;
computing a second approximating function using a second set of input data and the second set of output data.

6. The method as recited in claim 5, wherein utilizing an SCG to compute the first approximating function comprises
utilizing an SCG for multivariate functions to compute the first approximating function.

7. The method as recited in claim 5, wherein utilizing an SCG to compute the first approximating function comprises
utilizing an SCG in which functions are represented by look-up-tables to compute the first approximating function.

8. The method as recited in claim 5, wherein utilizing an SCG to compute the first approximating function comprises
utilizing a stochastic conjugate gradient method on functions (SCGF) to compute the first approximating function

9. The method as recited in claim 8, wherein utilizing an SCGF to compute the first approximating function comprises
utilizing an SCGF for multivariate functions to compute the first approximating function.

10. The method as recited in claim 5, wherein utilizing an SCG to compute the first approximating function comprises
utilizing an SCG with multiple iterations to compute the first approximating function.

11. The method as recited in claim 5, further comprising
computing a residual using the first set of input data and the first set of output data;
computing a search direction based on the residual and the set of basis functions.

12. The method as recited in claim 11, wherein computing the second approximating function using the second set of input data and the second set of output data comprises
computing the second approximating function additionally using the search direction.

13. The method as recited in claim 5, wherein generating a second set of output data using the first approximating function comprises
using the first approximating function as a predistorter.

14. A function approximator comprising:
interface circuitry; and
logic circuitry, coupled to the interface circuitry,
adapted to utilize a stochastic conjugate gradient method (SCG) to iteratively compute a first approximating function using a set of basis functions,
adapted to receive via the interface circuitry output data generated using the first approximating function, and
adapted to compute a second approximating function using the output data.

15. The function approximator as recited in claim 14, wherein the logic circuitry comprises at least a portion of a field-programmable gate array (FPGA).

16. The function approximator as recited in claim 14, wherein the logic circuitry comprises at least a portion of an application-specific integrated circuit (ASIC).

17. The function approximator as recited in claim 14, wherein the logic circuitry comprises a memory unit.
